(19) United States
(12) Patent Application Publication
(10) Pub. No.: US 2012/0198434 A1
(43) Pub. Date: Aug. 2, 2012

(54) VIRTUAL BUNDLING OF REMOTE DEVICE FIRMWARE UPGRADE

(75) Inventors: Adam D. Dirstine, Rochester, MN (US); Christopher Glen Popp, Winona, MN (US)

(73) Assignee: Digi International Inc., Minnetonka, MN (US)

(21) Appl. No.: 13/363,095

(22) Filed: Jan. 31, 2012

Related U.S. Application Data
(60) Provisional application No. 61/437,934, filed on Jan. 31, 2011.
(60) Provisional application No. 61/437,829, filed on Jan. 31, 2011.

(51) Int. Cl. G06F 9/44; G06F 9/445

(52) U.S. Cl. 717/170; 717/172; 717/173

(57) ABSTRACT

A networked firmware management system is operable to manage firmware in one or more target devices by receiving a virtual bundled firmware update package comprising two or more individual firmware update files. The system identifies one or more networked target devices having a virtual firmware target matching the virtual bundled firmware update package, and sends the virtual bundled firmware update package to the virtual firmware target on the one or more networked devices.

### CLAIM OF PRIORITY

The present application claims the benefit of priority, under 35 U.S.C. Section 119(e), to U.S. Provisional Patent Application Ser. No. 61/437,934, entitled “Virtual Bundling Of Remote Device Firmware Upgrade,” filed on Jan. 31, 2011, (Attorney Docket No. 977.163PRV), and U.S. Provisional Patent Application Ser. No. 61/437,829, entitled “Remote Firmware Upgrade Device Mapping,” filed on Jan. 31, 2011, (Attorney Docket No. 977.162PRV) which are hereby incorporated by reference herein in their entirety.

### TECHNICAL FIELD

This document pertains generally to managing firmware upgrades, and more specifically to embodiments of virtual bundling of a remote device firmware upgrade.

### COPYRIGHT NOTICE

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Although computer networks have become relatively common both in office and in home networking environments, such networks are typically fairly sophisticated and require significant processing power, electrical power, and infrastructure to work well. Some networking applications do not require so robust a network environment, but can benefit from the ability to provide electronic communications between devices.

One such example is the Bluetooth® technology that enables a cell phone user to associate and use an earpiece in what is sometimes referred to a personal area network or PAN. Another example is a mesh network, in which a number of devices work together to form a mesh, such that data can be sent from a source device to a destination device via other devices in the mesh network.

Mesh networks are often controlled by a gateway or coordinator device that acts as an interface between the mesh network and the Internet. Many networks such as these are large, comprising tens or hundreds of nodes spread out over a wide area. The gateway device and network nodes in many embodiments are inactive or asleep most of the time, and become active based on a coordinated schedule to perform various operations and communicate with other network nodes.

Further, a variety of node and gateway devices are often employed in complex network installations, including devices from a variety of manufacturers and that perform a variety of different monitoring and control functions. The variety of smart energy, fleet management, medical device networking, and other sensors, controllers, actuators, meters in a network are further often distributed across a wide area, and include geographically remote locations that make centralized control desirable.

Many devices also rely on more than one piece of firmware code to operate, such as devices that employ an operating system, boot code, application code, and other such code to operate. Managing multiple firmware files on some networked devices only adds to the complexity of ensuring that every device has the intended firmware revision, and that the firmware versions on nodes with multiple firmware images are all compatible and at the version desired.

Managing and updating gateway and other such devices distributed over large or complex networks such as these is therefore desired.

### SUMMARY

Networked firmware management systems and methods operable to manage firmware in one or more target devices by receiving a virtual bundled firmware update package comprising two or more individual firmware update files. Systems can identify one or more networked target devices having a virtual firmware target matching the virtual bundled firmware update package, and can send the virtual bundled firmware update package to the virtual firmware target on the one or more networked devices.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram showing an example environment comprising a server and a plurality of target gateway devices, according to an embodiment.

FIG. 2 is a block diagram illustrating a virtual bundled firmware update sent from a server to a networked device, according to an embodiment.

FIG. 3 is a flowchart showing a method of applying a virtual bundled firmware update to one or more networked target devices, according to an embodiment.

FIG. 4 illustrates exchange of data between a server and a target device, consistent with an example embodiment of the invention.

FIG. 5 is a flowchart showing a method of managing firmware in one or more target devices, consistent with an example embodiment of the invention.

### DETAILED DESCRIPTION

In the following detailed description of example embodiments, reference is made to specific examples by way of drawings and illustrations. These examples are described in sufficient detail to enable those skilled in the art to practice the invention, and serve to illustrate how the invention may be applied to various purposes or embodiments. Other embodiments exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Mesh networks are often used to route data between various elements or nodes in a network made up of a number of loosely assembled nodes. Many mesh networks are designed such that a compatible node can easily join the network and receive and send data, including passing received data long a route to an intended destination node. Mesh networks are therefore often self-healing, in that if a node becomes inoperable or loses a connection to another node, data can be easily routed around the broken network link.

Many mesh network technologies use wireless communication, further enhancing the ease of use of mesh networking for certain applications. Because mesh network nodes are typically stationary, wireless connections between various nodes can be formed and characterized by searching a known frequency or radio band for other mesh network nodes as new wireless nodes are added to the mesh network. Recent reductions in cost and advancement in wireless networking technology has made use of mesh networking for a variety of applications a desirable alternative to using a more structured network such as a TCP/IP network.

One example of a mesh network standard using wireless radio communication is the ZigBee® mesh network, which was developed by an industry alliance and is related to IEEE standards including 802.15.4™. The retail price of ZigBee-compliant transceivers is nearly a dollar, and a transceiver, memory, and processor can be bought for a few dollars in quantity, making integration of mesh network technology into inexpensive electronic devices economically practical. The standard is intended to support low power consumption at reasonably low data rates, and provides a self-organizing network technology that works well for applications such as control, monitoring, sensing, and home automation.

In an example of wireless mesh technology, one node operates as a gateway or coordinator, forming the root of the mesh network and performing other functions such as bridging to other networks and handling encryption keys. Most nodes are router nodes, which include a processor and network interface that can receive and send data, including passing data along to other nodes. In some embodiments, end device nodes contain just enough network or processing hardware and instruction functionality to receive and send data, but cannot route or pass data from a sending node to a different receiving node. While this preserves battery life and reduces the cost of the node, end device nodes are unable to contribute to the routing functions of the mesh network, and so will typically not make up a large percentage of a mesh network's nodes.

Nodes in some mesh networks can also conserve power by entering a sleep mode, or becoming inactive for extended periods of time when operation is not necessary. For example, a mesh network of ground moisture sensors may only need to take and report measurements every two hours, and need only be awake for a few milliseconds every two hour period. The sleeping nodes in such a network are desirably synchronized by the coordinator during configuration of the network so that they wake at the same time, enabling the nodes to communicate with each other while awake.

The wide variety of smart energy, fleet management, medical device networking, and other sensors, controllers, actuators, meters and other such devices that are found in many networks can add complexity to management of network devices such as these. Management can become increasingly complex with network nodes are not homogenous. For example, gateway controllers may be from a variety of manufacturers, and configured differently to perform different functions and control different mesh network devices. A typical gateway device may also have a variety of firmware elements that are often updated to fix or improve functionality, such as the operating system, boot loader, and applications.

As the number of gateway devices grows and the firmware becomes more complex, management of firmware images on a variety of devices across a network can become a difficult task. In many installations, software code on a central server is custom written to send specific firmware updates to specific target devices such as gateways, requiring knowledge of the identity of the variety of gateway devices in the network and the firmware images associated with each device.

Further, some network devices may have multiple firmware images loaded to the same device, such as an operating system, a program or application, boot code or BIOS code, and other such firmware. Because these pieces of firmware code typically work with one another to perform the various functions of a computerized device, they are often dependent on one another to support the same functions and to operate in an expected way.

Managing the version of each firmware component installed on each of several different attached devices can therefore be a daunting task, particularly when certain firmware elements must be installed with certain versions of other firmware elements to ensure compatibility.

One example embodiment of the invention therefore provides for managing firmware images installed on networked devices by virtual bundling of firmware. More specifically, a device attached to a server via a network can have multiple firmware targets on the device, such as for an operating system, a program or application, boot code or BIOS code, and other such firmware, and multiple firmware images for multiple targets per device are bundled into a firmware upgrade.

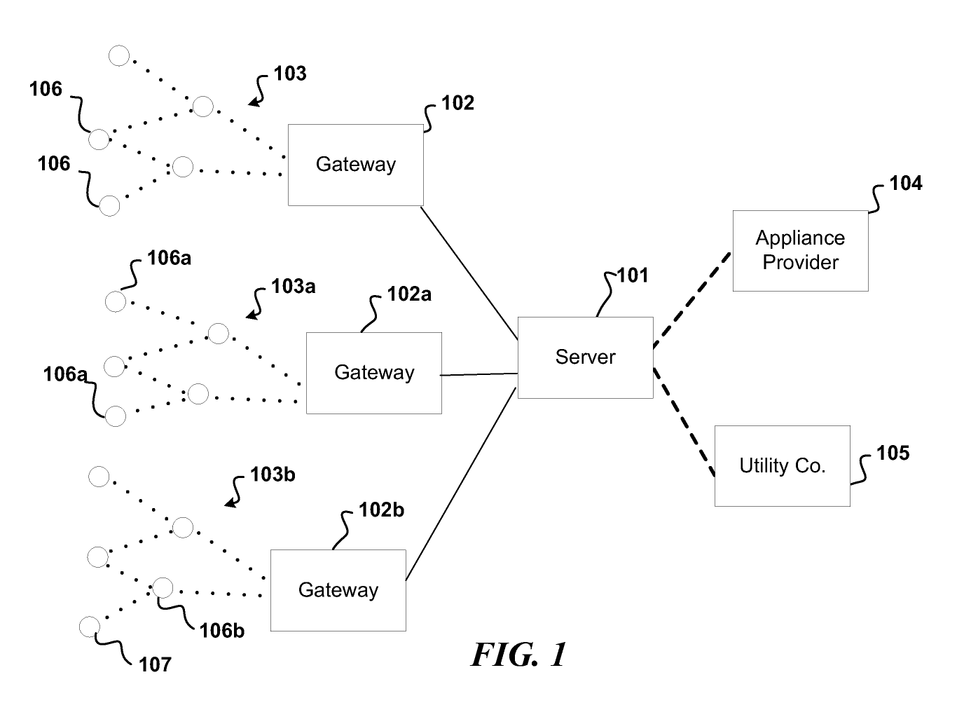

FIG. 1 is a block diagram showing an example network comprising a number of gateway devices and a server, consistent with an example embodiment of the invention. Here, a server 101 such as an iDigi® server is coupled to a number of gateway devices 102. Each of the gateway devices is further linked to a network, such as an iDigi® or ZigBee® mesh network 103. The server 101 in this example is further coupled to other clients, such as appliance provider 104 and utility company 105. The mesh network can include a plurality of mesh network devices 106 that can include router functionality similar to that of a gateway device 102 or be a leaf node 107 that includes only minimal communication and processing capabilities.

In operation, the mesh network devices 106 collect data, such as power consumption data or other such data and relay it to a gateway 102. The gateway is operable to receive data from the mesh network 103, coordinate operation of the mesh network devices 106, and provide received data to server 101. The server 101 receives the data from the mesh network device nodes 106, such as power consumption data and device state data, and is able to forward this information to other parties such as to a utility company 105, an appliance manufacturer 104, or to a building owner via a web interface to monitor things such as power usage and appliance status.

It is not uncommon for mesh network device and gateway providers to provide improved functionality to the devices via firmware updates, such as may be downloaded to the server 101 from the utility company 105 or appliance company 104. A device such as gateway 102 typically identifies how many firmware targets it supports upon connecting with the server 101, along with other data such as a simple description of each target. Firmware for the targets within a device are often version dependent, in that compatible versions of at least some of the firmware targets must be installed within the device to ensure proper operation of the device.

This becomes difficult to manage as multiple gateway devices 102 support multiple firmware targets. Some example embodiments of the invention therefore bundle firmware in a virtual bundle, so that all firmware images in the bundle are installed or fail installation as a group.

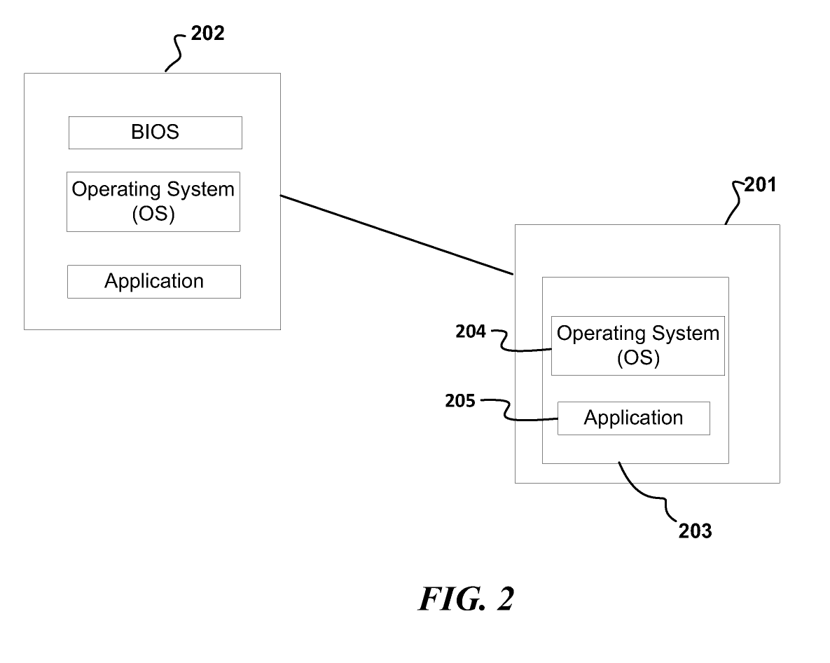

In a further example shown in FIG. 2, bundling firmware in such a manner ensures that all firmware images contained in the virtual bundled firmware update package can be installed as a package, and any installed components of the bundle can be backed out if any firmware component update in the package fails.

Here, a server 201 is coupled to at least one gateway device 202, as in FIG. 1. A bundled firmware image 203 is stored on the server 201, for distribution to the gateway device 202. When the gateway device 202 receives the bundled firmware package 203, it extracts both the operating system or OS firmware update 204, and the application update 205. Here, a third firmware BIOS target is also present in the gateway device 202, but is not updated as part of the firmware update bundle 203. An alternative firmware image bundle can include a bios update separately or as part of the bundled firmware image 203.

Because the versions of the operating system and application are dependent on one another to work properly in this example, the operating system and application images are installed as a bundle. If either the operating system or the application installation fails, both the operating system and application firmware updates are backed out or uninstalled and the previous firmware is restored, so that compatible firmware images remain installed on the various firmware targets in the gateway device.

The bundle in a further example is handled as a virtual firmware bundle, meaning it can be managed as though it addresses a single firmware target in the gateway device 202. It therefore reports either success or failure of the virtual firmware bundle installation as a whole, and does not install partial firmware updates or give partial failure or success responses for individual targets contained in the bundle to the server. This ensures that only versions of various firmware components that are compatible with one another remain installed on a firmware target, simplifying the task of managing versions where multiple firmware targets exist in a device.

It is not uncommon some devices to have a relatively low communications bandwidth, such as a mesh network device 106 that is only on and active periodically or a cellular telephone network device that has a low data rate and communicates only periodically. It may take such a device hours or days to download each firmware file for a device having multiple targets, and installation of individual firmware files as they are received can result in version incompatibility or other such problems. Use of virtual bundled firmware installed as though it is a single firmware update by waiting until all firmware files that are a part of a virtual bundle before any firmware update file is installed ensures that such version incompatibilities do not exist for hours or days while other firmware files are downloaded and installed, decreasing the chances that a firmware incompatibility will result in a malfunctioning device.

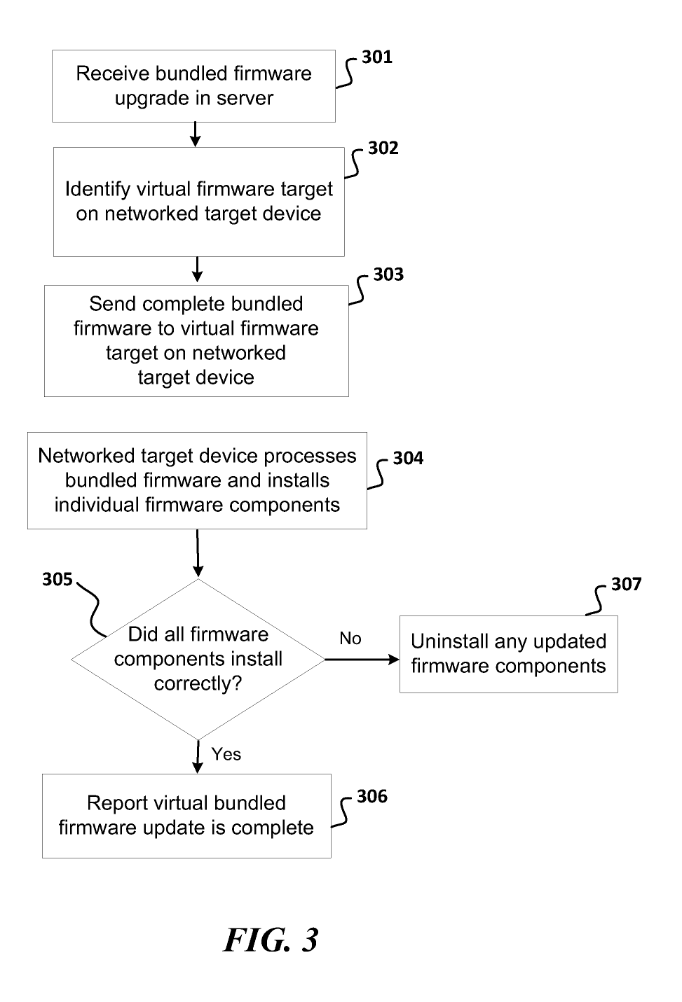

FIG. 3 is a flowchart detailing installation of a virtual bundled firmware update, consistent with an example embodiment of the invention. At 301, a bundled firmware update is received in a server, such as server 101 of FIG. 1, from an appliance or utility provider 104 or 105. The server identifies at 302 a virtual firmware target on a networked device such as 102 that corresponds to the virtual bundled firmware update received at 301. The server then sends the complete virtual bundled firmware update package to the virtual firmware target on the networked target device at 303, ensuring that the networked device has the entire virtual bundled firmware package before the device installs any portion of the firmware bundle.

At 304, the networked target device has received the entire virtual bundled firmware update package, and performs optional steps such as checking the integrity of the bundle by looking for a hash signature or performing another such authentication or integrity check. The individual firmware files in the bundled firmware update are then installed.

If all the firmware update components in the virtual bundled firmware update package are determined to have installed correctly at 305, the device then reports that the firmware update was successful at 306. If one or more of the files installs incorrectly or incompletely, any other updated firmware components that are part of the virtual firmware bundle are uninstalled at 307 to retain the previous firmware versions across the device.

The firmware update process in other embodiments includes variations of this method, such as retrying individual firmware components before concluding that the virtual bundled firmware update has failed, or uninstalling previous firmware versions, installing updates in a different order, and other such variations to attempt to successfully complete the firmware update.

An example firmware update process can include distributing a virtual bundled firmware update to a plurality of network nodes, such as a mesh network device 106 and gateway 102, over a period of time and coordinating the update of each individual device to occur in a set window or time period. Each individual device that is to be upgraded can propagate an acknowledgement that the entire virtual bundled firmware update has been received that that it is awaiting an execute or all-ready command to begin the installation of the update. The execute command can be coordinated and provided by the server 101 or a gateway 102. In this example embodiment multiple devices can be updated with one or more firmware components in a nearly simultaneous manner. A nearly simultaneous upgrade of multiple mesh network devices can provide a mechanism to upgrade software application or operating system components related to the communication mechanism or protocol that each mesh node device utilizes to communicate over the mesh network, thereby preventing or minimizing periods where one or more nodes could be excluded from the mesh network due to incompatibilities between software or firmware versions on one or more nodes.

Some embodiments of the invention can use a specification identifying a firmware file or image bundle as part of the gateway device configuration sent to the server 101. The server 101 therefore knows what identifiers can be used to recognize various firmware images or image bundles, associate them with various gateway device targets, and update the appropriate targets on the gateway devices.

The firmware specification in a further example comprises a file name string or image bundle identifier, such that the gateway passes a text string to the server that is intended to match at least a portion of the file name or image bundle identifier of any firmware update for a specific firmware target on the gateway device. For example, an energy monitoring network's gateway device 102 may have firmware target specifications including names such as “energymonitorbootloader” “energymonitoroperatingsystem” “energymonitorapplication”, and “energymonitorconfiguration”. When the server receives a new firmware file titled “energymonitorapplication14325”, it can match the gateway device's firmware target file name specification “energymonitorapplication” to the firmware's file name “energymonitorapplication14325”, and update the firmware.

This is performed in a further example by matching an attribute such as the file name of any new firmware file uploaded to the server 101 to a record of firmware target specifications registered by various attached devices, such as gateways 102. The firmware file's attribute is compared to each of the registered firmware target specifications, so that the file can be applied to all matching firmware targets. If multiple devices such as gateways 102 have some or all firmware targets in common, uploading a single firmware file will result in distribution to each of the matching targets that are registered in the server, sparing a user from manually uploading the firmware to each of a potentially large number of gateway or other devices 102.

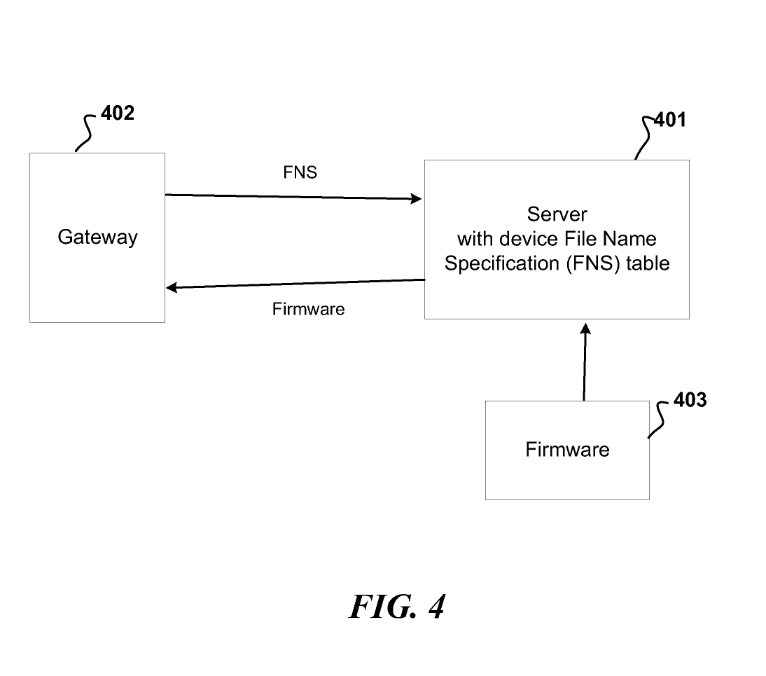

FIG. 4 illustrates data exchange between a server and a gateway device, consistent with an example embodiment of the invention. The server 401 and gateway 402 are coupled via a network, such as the Internet, facilitating the exchange of data. In other examples, cellular data networks or other suitable networks are employed, enabling communication such as to devices that are not easily directly wired to a network.

The server 401 includes a device file name specification table, as shown in FIG. 4, used to store file name specification data or image bundle identifiers received from various attached devices such as gateway 402. The server is also operable to store firmware files or image bundles, such as were downloaded from third party network servers 403, as shown in the example of FIG. 1.

In operation, the server 401 establishes communication with a gateway device 402, and the gateway device 402 sends device identification information to the server 401. This includes firmware metadata, including a file name specification for one or more firmware targets on the gateway 402. The file name specification is stored in a file name specification table in the server 401, where it can be used for associating received firmware files with various gateway firmware targets.

When the server 401 obtains new firmware, such as by user-initiated or automatic downloading of firmware from a remote server 403 such as the utility or appliance company servers in the example of FIG. 1, firmware identifying information is extracted from the firmware. This includes in this example examination of the firmware's file name, but in other examples will include other characteristics such as a character string within the firmware, file type or extension, image bundle identifier, or other such characteristics.

The firmware identifying information extracted from the received firmware file is compared to the file name specification stored in the file name specification table on the server 401, and any matches are identified. The firmware image or bundle is then sent to each of the matching firmware targets on each of the gateway devices 402, and the firmware is sent to the appropriate targets and is updated on the targets. Targets can include, but are not limited to, the gateway devices 102 or the network devices 103 shown in FIG. 1.

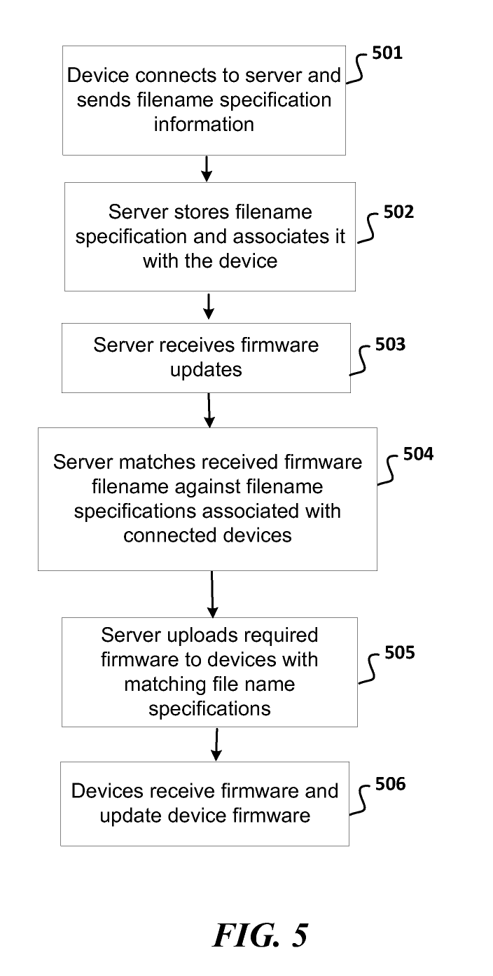

This process is illustrated in the flowchart of FIG. 5, which shows an example of using file name specifications to perform firmware updates. At 501, a device such as a mesh network gateway, mesh network node, or other networked device connects to the server and sends file name specification information for one or more firmware targets in the device.

The server stores the file name specification in a file name specification table at 502, and associates the stored specification with the specific device and in some further embodiments a specific firmware target on the device.

The server receives a firmware update at 503, such as by a user retrieving a firmware file from a third-party website, or automated querying and download of new firmware images from a third-party server. The server matches the firmware file name against the file name specification fields in the file name specification table, and identifies any matching firmware targets or devices at 504. The server then uploads the firmware to any matching devices or targets at 505, and the devices receive the firmware and perform a firmware update at 506.

Although the examples presented here use mesh network gateways as firmware target devices, firmware targets in other embodiments include devices such as mesh network nodes, cellular data network nodes, and networked devices such as security, energy, and environmental monitoring and control devices. Similarly, the file name specification is but one example of a firmware attribute that can be sued to match a firmware file with an appropriate target, and other characteristics such as a substring within the firmware file, file extension, or other such characteristic can be used to match firmware files to targets.

In one such more detailed example, a mesh network device coupled to a gateway sends a file name specification or image bundle identifier associated with a firmware target on the mesh network device to the gateway. The gateway then forwards this file name specification or image bundle identifier to the server, which sends the target device firmware updates matching the file name specification or image bundle identifier. When the gateway receives such a firmware update, it forwards the update to the mesh network device, thereby updating the mesh network device's firmware.

The examples presented here illustrate how a virtual bundled firmware can be used to perform firmware updates for multiple firmware targets in a device in a network environment, applied as though the virtual bundled firmware update was applied to a single target. The virtual bundled firmware and virtual device target ensure that compatibility is maintained between different update components in the firmware update package on each target device.

Although specific embodiments have been illustrated and described herein, it will be appreciated by those of ordinary skill in the art that any arrangement which is calculated to achieve the same purpose may be substituted for the specific embodiments shown. The invention may be implemented in various modules and in hardware, software, and various combinations thereof, and any combination of the features described in the examples presented herein is explicitly contemplated as an additional example embodiment. This application is intended to cover any adaptations or variations of the example embodiments of the invention described herein. It is intended that this invention be limited only by the claims, and the full scope of equivalents thereof.

What is claimed is:

1. A method of updating firmware in a networked device, comprising:
receiving a virtual bundled firmware update package comprising two or more individual firmware update files;
identifying one or more networked target devices having a virtual firmware target matching the virtual bundled firmware update package; and
sending the virtual bundled firmware update package over a network to the virtual firmware target on the one or more networked target devices.

2. The method of updating firmware in a networked device of claim 1, wherein receiving a virtual bundled firmware update package comprises downloading the virtual bundled firmware update package from a device provider Internet service.

3. The method of updating firmware in a networked device of claim 1, wherein the virtual bundled firmware update package further comprises a list of firmware components and a list of targets associated with the firmware components within the networked target device

4. The method of updating firmware in a networked device of claim 1, wherein identifying one or more networked target devices having a virtual firmware target matching the virtual bundled firmware update package comprises polling networked devices for a virtual target ID.

5. The method of updating firmware in a networked device of claim 1, wherein identifying one or more networked target devices having a virtual firmware target matching the virtual bundled firmware update package comprises identifying the virtual target and associated attached device in a directory.

6. A networked device firmware update server, comprising:
a firmware update module operable to identify one or more networked target devices having a virtual firmware target matching a virtual bundled firmware update package comprising two or more individual firmware update files; and
the firmware update module further operable to send the virtual bundled firmware update package to the virtual firmware target on the one or more networked devices.

7. The networked device firmware update server of claim 6, further comprising a firmware receiving module operable to receive a virtual bundled firmware update package.

8. The networked device firmware update server of claim 7, wherein receiving a virtual bundled firmware update package comprises downloading the virtual bundled firmware update package from a device provider Internet service.

9. The networked device firmware update server of claim 6, wherein the virtual bundled firmware update package further comprises a list of firmware components and a list of targets associated with the firmware components within the networked target device

10. The networked device firmware update server of claim 6, wherein identifying one or more networked target devices having a virtual firmware target matching the virtual bundled firmware update package comprises at least one of polling networked devices for a virtual target ID and identifying the virtual target and associated attached device in a directory.

11. A method of updating firmware in a networked device, comprising:
receiving a virtual bundled firmware update package comprising two or more individual firmware update files from a server; and
installing the two or more individual firmware update files from the virtual bundled firmware update package, as though the virtual bundled firmware update package is installed to a single firmware target such that the virtual bundled firmware update completes successfully only if each of the two or more individual firmware updates complete successfully.

12. The method of updating firmware in a networked device of claim 11, further comprising retrying any individual firmware updates that failed installation.

13. The method of updating firmware in a networked device of claim 11, further comprising reverting any individual firmware updates that were installed to the previous version if any individual firmware update fails installation.

14. The method of updating firmware in a networked device of claim 11, wherein the virtual bundled firmware update package further comprises a list of firmware components and a list of targets associated with the firmware components within the networked target device.

15. A networked device, comprising:
a communications module operable to receive a virtual bundled firmware update package comprising two or more individual firmware update files from a server; and
a firmware update module operable to install the two or more individual firmware update files from the virtual bundled firmware update package, as though the virtual bundled firmware update package is installed to a single firmware target such that the virtual bundled firmware update completes successfully only if each of the two or more individual firmware updates complete successfully.

16. The networked device of claim 15, the firmware update module further operable to retry any individual firmware updates that failed installation.

17. The networked device of claim 15, the firmware update module further operable to revert any individual firmware updates that were installed to the previous version if any individual firmware update fails installation.

18. The networked device of claim 15, wherein the virtual bundled firmware update package further comprises a list of firmware components and a list of targets associated with the firmware components within the networked target device.

19. A method of managing firmware updates in a mesh networked system, comprising:
receiving, in a server, two or more firmware target specifications from two or more target devices, the firmware target specifications each identifying one or more firmware targets in the target devices;
storing the one or more received firmware target specification in the server, associated with each of the one or more firmware targets in the target device;
receiving a bundled firmware update package comprising one or more individual firmware update files;
identifying two or more networked target devices having a firmware target matching the bundled firmware update package; and
sending the bundled firmware update package over a network to the two or more target devices.

20. A method of managing firmware updates in a mesh networked system of claim 19, comprising:
receiving an indication that the two or more target devices successfully received the bundled firmware update package; and
sending a notification of each of the two or more target devices coordinating the installation of the bundled firmware update package on the target devices.
